(19) United States
(12) Patent Application Publication
(10) Pub. No.: US 2009/0002310 A1
(43) Pub. Date: Jan. 1, 2009

(54) LIQUID CRYSTAL DISPLAY APPARATUS

(75) Inventors: Seiji Kawaguchi, Osaka (JP); Shigesumi Araki, Ishikawa (JP); Kazuhiro Nishiyama, Ishikawa (JP); Kenji Nakao, Ishikawa (JP); Ken Shiiba, Ishikawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 12/145,077

(22) Filed: Jun. 24, 2008

(30) Foreign Application Priority Data
Jun. 25, 2007 (JP) 2007-166439
May 12, 2008 (JP) 2008-124422

(51) Int. Cl. G09G 3/36

(52) U.S. Cl. 345/102

(57) ABSTRACT

A liquid crystal display apparatus in an embodiment of the invention, in which each frame period is divided into a first period for writing the non-video signals, a second period for writing the video signals to the respective pixels, and a third period for maintaining the video signals in the respective pixels; and in which a control unit (1) calculates a backlight luminance value and gamma conversion values based on the distribution of the gradation values prior to the second period, (2) gamma-converts the input video signals based on the gamma conversion values and writes gamma-converted video signals into the respective pixels during the second period, (3) causes the backlight to emit light based on the backlight luminance value during the third period.

### CROSS-REFERENCE TO RELATED APPLICATIONS

This application is based upon and claims the benefit of priority from the prior Japanese Patent Application No. 2007-166439, filed on Jun. 25, 2007 and Japanese Patent Application No. 2008-124422, filed on May 12, 2008; the entire contents of which are incorporated herein by reference.

### TECHNICAL FIELD

The present invention relates to a liquid crystal display apparatus.

### BACKGROUND OF THE INVENTION

In the liquid crystal display apparatus, since the contrast or the luminance of displayed video is not sufficient in general, various methods for obtaining a good contrast and obtaining a high-quality video are proposed (for example, see JP-A-1995(H07)-281633, that is, Japanese Patent Application Publication No. 07-281633 (KOKAI)).

As one of the technologies for improving the insufficient contrast as described above, a method of achieving the effect by a backlight attached to the liquid crystal display apparatus as described above is proposed. In the method of improving the contrast by the backlight, there is a case in which a flashing is generated. The flashing is a state in which part of the display is lightened for a moment when the screens of all frames are dark images because one frame period is required for ending scanning of the image to be displayed when changing the luminance of the backlight simultaneously with the image to be displayed.

Therefore, in order to prevent the flashing, it is necessary to add an algorithm. In other words, the timing of illumination of the backlight is shifted to the timing after one frame period is ended. However, there is a problem such that such algorithm may deteriorate response in terms of display.

In view of the above, it is aimed to curb flashing and deterioration of response in terms of display.

### BRIEF SUMMARY OF THE INVENTION

According to an embodiment of the invention, a liquid crystal display apparatus comprises: a liquid crystal panel having a plurality of signal lines, a plurality of scanning lines and a plurality of pixels arranged in a matrix form; a backlight that illuminates the liquid crystal panel; a source driver that outputs video signals and non-video signals to the respective signal lines; a gate driver that outputs gate signals to the respective scanning lines; and a control unit that stores an input video signals and calculates distribution of gradation values of the input video signals, and that controls the backlight, the source driver, and the gate driver based on the input video signal and the distribution of gradation values during each frame period which is divided into a first period for writing the non-video signals to the respective pixels, a second period subsequent to the first period for writing the video signals to the respective pixels, and a third period subsequent to the second period for maintaining the video signals in the respective pixels; wherein the control unit (1) calculates a backlight luminance value and gamma conversion values based on the distribution of the gradation values prior to the second period, (2) gamma-converts the input video signals based on the gamma conversion values and writes gamma-converted video signals into the respective pixels during the second period, and (3) causes the backlight to emit light based on the backlight luminance value during the third period.

According to another embodiment of the invention, a liquid crystal display apparatus comprises: a liquid crystal panel having a plurality of signal lines, a plurality of scanning lines and a plurality of pixels arranged in a matrix form; a backlight that illuminates the liquid crystal panel; a source driver that outputs video signals and non-video signals to the respective signal lines; a gate driver that outputs gate signals to the respective scanning lines; and a control unit that stores an input video signals and calculates distribution of gradation values of the input video signals, and that controls the backlight, the source driver, and the gate driver based on the input video signal and the distribution of gradation values during each frame period which is divided into a first period for writing the non-video signals to the respective pixels, a second period subsequent to the first period for writing the video signals to the respective pixels, and a third period subsequent to the second period for maintaining the video signals in the respective pixels, wherein the control unit (1) calculates a backlight luminance value and gamma conversion values based on the distribution of the gradation values during the first period, (2) gamma-converts the input video signals based on the gamma conversion values and writes gamma-converted video signals into the respective pixels during the second period, and (3) causes the backlight to emit light based on the backlight luminance value during the third period.

According to a still other embodiment of the invention, a liquid crystal display apparatus comprises: a liquid crystal panel having a plurality of signal lines, a plurality of scanning lines and a plurality of pixels arranged in a matrix form; a backlight that illuminates the liquid crystal panel; a source driver that outputs video signals to the respective signal lines; a gate driver that outputs gate signals to the respective scanning lines; and a control unit that stores an input video signals and generates gradation scale information of the input video signals, and that controls the backlight, the source driver, and the gate driver based on the input video signal and the gradation scale information during each frame period which is divided into a first period for writing the video signals to the respective pixels, and a second period subsequent to the first period for maintaining the video signals in the respective pixels, wherein the control unit (1) calculates a backlight luminance value and gamma conversion values based on the gradation scale information prior to the first period, (2) gamma-converts the input video signals based on the gamma conversion values, writes gamma-converted video signals into the respective pixels, and puts the backlight into off-state during the second period, and (3) puts the backlight into on-state based on the backlight luminance value during the second period.

According to a further embodiment of the invention, a liquid crystal display apparatus comprises: a liquid crystal panel having a plurality of signal lines, a plurality of scanning lines and a plurality of pixels arranged in a matrix form; a backlight that illuminates the liquid crystal panel; a source driver that outputs video signals and non-video signals to the respective signal lines; a gate driver that outputs gate signals to the respective scanning lines; and a control unit that stores an input video signals and calculates gradation scale information of the input video signals, and that controls the backlight, the source driver, and the gate driver based on the input video signal and the gradation scale information during each frame period which is divided into a first period for writing the non-video signals to the respective pixels, a second period subsequent to the first period for writing the video signals to the respective pixels, and a third period subsequent to the second period for maintaining the video signals in the respective pixels, wherein the control unit (1) calculates a backlight luminance value and gamma conversion values based on the gradation scale information prior to the second period, (2) gamma-converts the input video signals based on the gamma conversion values and writes gamma-converted video signals into the respective pixels during the second period, and (3) causes the backlight to emit light based on the backlight luminance value during the third period.

According to a still further embodiment of the invention, a liquid crystal display apparatus comprises: a liquid crystal panel having a plurality of signal lines, a plurality of scanning lines and a plurality of pixels arranged in a matrix form; a backlight that illuminates the liquid crystal panel; a source driver that outputs video signals and non-video signals to the respective signal lines; a gate driver that outputs gate signals to the respective scanning lines; and a control unit that stores an input video signals and calculates gradation scale information of the input video signals, and that controls the backlight, the source driver, and the gate driver based on the input video signal and the gradation scale information during each frame period which is divided into a first period for writing the non-video signals to the respective pixels, a second period subsequent to the first period for writing the video signals to the respective pixels, and a third period subsequent to the second period for maintaining the video signals in the respective pixels, wherein the control unit (1) calculates a backlight luminance value and gamma conversion values based on the gradation scale information during the first period, (2) gamma-converts the input video signals based on the gamma conversion values and writes gamma-converted video signals into the respective pixels during the second period, and (3) causes the backlight to emit light based on the backlight luminance value during the third period.

By the embodiments of the invention, the flashing phenomenon is completely prevented.

### BRIEF DESCRIPTION OF THE DRAWINGS

FIG. 1 is a block diagram of a liquid crystal display apparatus according to a first embodiment of the invention;

FIG. 2 is a block diagram of a controller;

FIG. 3 is a timing chart when displaying a video;

FIG. 4 is a timing chart for displaying a video according to a second embodiment;

FIG. 5 is a timing chart for displaying a video according to a third embodiment;

FIG. 6 is a timing chart for displaying a video according to a fourth embodiment;

FIG. 7 is a timing chart for displaying a video according to a fifth embodiment;

FIG. 8 is a timing chart for displaying a video according to a sixth embodiment;

FIG. 9 is a perspective view of the liquid crystal display apparatus according to the sixth embodiment;

FIG. 10 is Modification 1 of a backlight according to the sixth embodiment; and

FIG. 11 is Modification 2 of the backlight according to the sixth embodiment.

### DETAILED DESCRIPTION OF THE INVENTION

Referring now to the drawings, a liquid crystal display apparatus according to embodiments of the invention will be described.

### First Embodiment

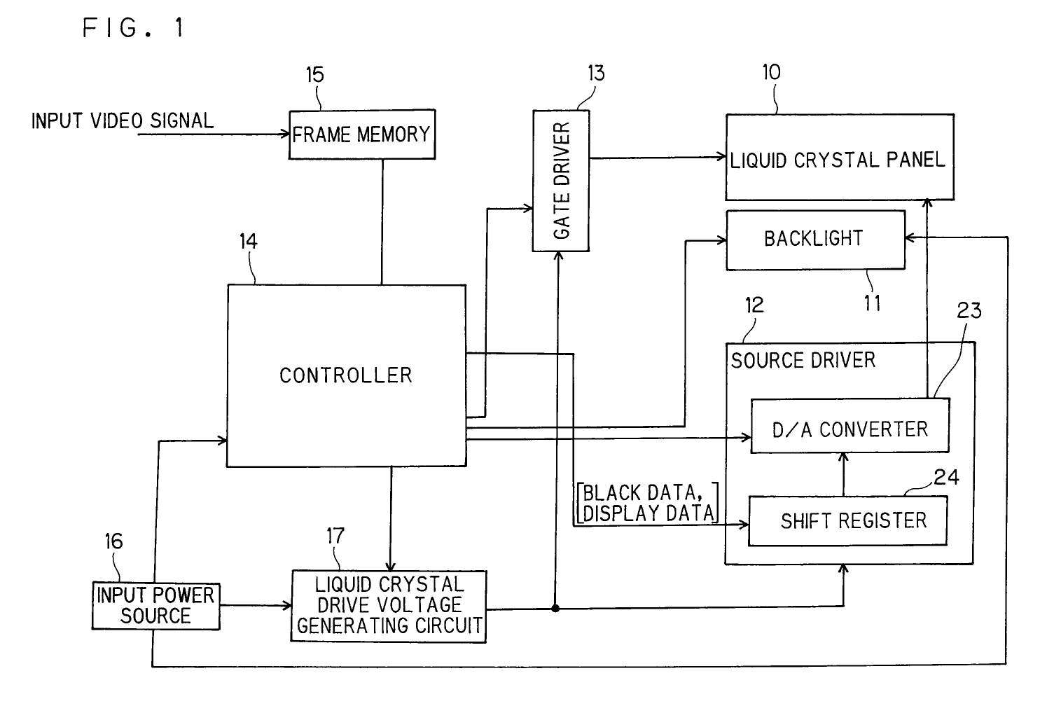

Referring now to FIG. 1 to FIG. 3, a liquid crystal display apparatus of an OCB-mode in a first embodiment of the invention will be described.

### (1) Configuration of Liquid Crystal Display Apparatus

Referring now to FIG. 1, a configuration of the liquid crystal display apparatus in the first embodiment will be described. FIG. 1 is a block diagram showing a configuration of the liquid crystal display apparatus of the OCB-mode.

The liquid crystal display apparatus of the OCB-mode includes, for example, a liquid crystal panel 10 of a size of 7 to 9 inches, a backlight 11, a source driver 12, a gate driver 13, a controller 14, a frame memory 15, an input power source 16 and a liquid crystal drive voltage generating circuit 17.

The liquid crystal panel 10 includes an array substrate and an opposed substrate, and the array substrate includes signal lines and scanning lines arranged so as to be orthogonal to each other and TFTs (thin film transistors) at intersections thereof, and liquid crystal of OCB mode is interposed between the array substrate and the opposed substrate. It is assumed that the liquid crystal panel 10 in the first embodiment includes the signal lines from first to m^{th} lines formed in the vertical direction, and the scanning lines from first to nth lines formed in the lateral direction. For example, in the case of WVGA (Wide Video Graphics Array), since there are 800 lines (×RGB)×480 lines, the value “n” is 480 (n=480) and the value “m” is 800 (m=800).

The backlight 11 is arranged on the back surface of the liquid crystal panel 10, and includes, for example, a light guide plate and a plurality of cold cathode tubes of a short afterglow type arranged at the end sides thereof. It is also possible to use a plurality of white LEDs instead of the cold cathode tubes as the light source. It is also possible to combine LEDs of red (R), green (G) and blue (B) when in use. Alternatively, the cold cathode tubes or the LEDs may be arranged on the back surface of the liquid crystal panel 10.

The frame memory 15 stores data of transmitted video signal temporarily. The frame memory 15 also stores data of a previous frame of the corresponding data temporarily.

The input power source 16 supplies an electric power to the backlight 11, the controller 14 and the liquid crystal drive voltage generating circuit 17, and the liquid crystal drive voltage generating circuit 17 adjusts a voltage to be supplied to the source driver 12 and the gate driver 13 according to the timing to display the display data on the liquid crystal panel 10.

The gate driver 13 supplies gate signals to the scanning lines of the liquid crystal panel 10, and the source driver 12 supplies voltages corresponding to the video signals to the signal lines of the liquid crystal panel 10.

The source driver 12 includes a D/A converter 23 and a shift register 24.

The controller 14 will be described later.

### (2) Display Operation in Liquid Crystal Display Apparatus

Referring now to FIG. 1, the display operation in the liquid crystal display apparatus will be described.

The video signals as the RGB data are accumulated temporarily in the frame memory 15. The controller 14 reads the frame data stored in the frame memory 15, and carries out gradation correction or gamma correction process for the video signals. Then, according to the start pulse, the controller 14 transfers the display data after having applied with the correction process to the shift register 24 of the source driver 12 by an amount corresponding to a row of pixels.

The controller 14 transfers data of black video data for preventing reverse transition to the shift register 24 by an amount corresponding to a row of pixels according to the start pulse.

Then, the controller 14 outputs a load pulse for the D/A converter 23 of the source driver 12. The D/A converter 23 acquires the data stored in the shift register 24 by an amount of a row of pixels simultaneously at the timing when the load pulse is entered, carries out the D/A conversion, and outputs the voltages corresponding to the respective display data to the signal lines of the liquid crystal panel 10.

At this time, the controller 14 controls the output timing of the pulsed gate signals (hereinafter, referred to as gate pulse) to be outputted from the gate driver 13 to the respective scanning lines and lights up the backlight 11 at the timing when the respective TFTs of the liquid crystal panel 10 respond the display data to display the display data on the liquid crystal panel 10.

### (3) Configuration of Controller 14

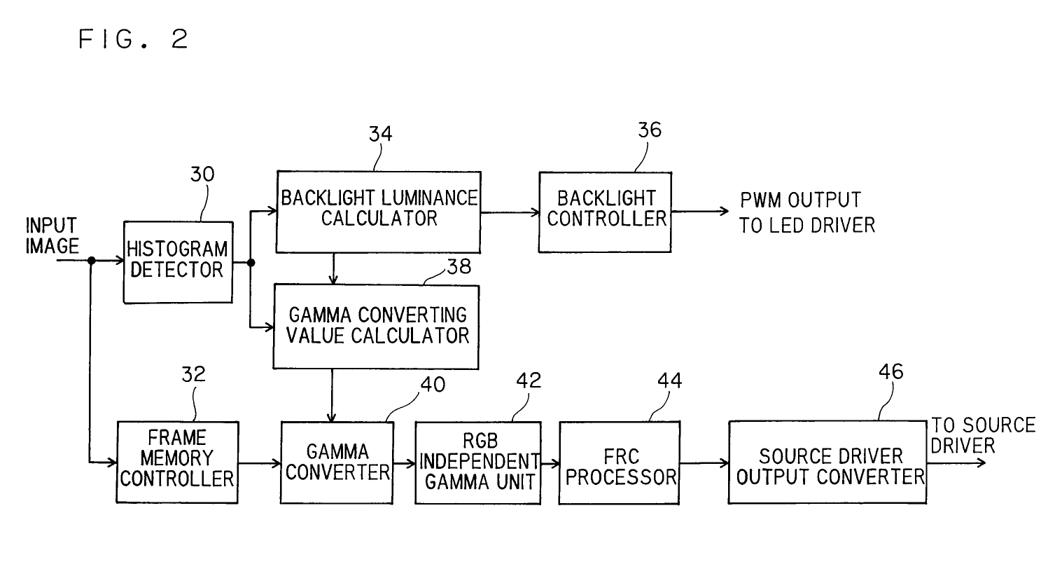

Referring now to FIG. 2, the detailed configuration of the signal processing carried out by the controller 14 will be described. FIG. 2 is a block diagram relating to the signal processing carried out by the controller 14.

As shown in FIG. 2, the controller 14 includes a histogram detector 30, a frame memory controller 32, a backlight luminance calculator 34, a backlight controller 36, a gamma converting value calculator 38, a gamma converter 40, an RGB independent gamma unit 42, an FRC processor 44, and a source driver output converter 46.

The histogram detector 30 counts the number of pixels included in the respective gradation ranges divided in advance, for example, into ten ranges, on the basis of the transmitted video signals in one frame period and generates a histogram based on the number of pixels (the number of pixels is an example of frequency of the pixels) included in the respective gradation ranges. The detected histogram is outputted to the backlight luminance calculator 34 and the gamma converting value calculator 38.

The frame memory controller 32 stores video signals for the one frame period in the frame memory 15.

The backlight luminance calculator 34 calculates the luminance of the backlight 11 on the basis of the histogram entered from the histogram detector 30. For example, when the frequency of the low gradation ranges is high in the histogram, the backlight luminance calculator 34 controls the luminance of the backlight 11 to a luminance lower than the normal luminance, and when the frequency of the high gradation ranges is high, it controls the luminance of the backlight 11 to a high luminance. The calculated backlight luminance value is outputted to the backlight controller 36.

The backlight controller 36 adjusts the luminance of the backlight 11 on the basis of the entered backlight luminance value. The adjustment is carried out by using a PWM (Pulse Width Modulation) Control Method for modulating the luminance by switching the periods of light emission and non-light emission rapidly. Therefore, the backlight controller 36 generates the PWM control signals on the basis of the backlight luminance signals and outputs the same to the backlight 11. The adjustment of the luminance of the backlight 11 may be achieved by controlling the amount of electrical current by itself instead of the method shown above.

The gamma converting value calculator 38 calculates a gamma converting value for correcting the gamma value of the entered video signals from the histogram and the backlight luminance value.

The gamma converter 40 changes the gamma curve of the video signals on the basis of the video signal entered from the frame memory controller 32 and the gamma converting values entered from the gamma converting value calculator 38. For example, when the luminance of the backlight 11 is lowered in comparison with the normal luminance on the basis of the histogram, the luminance is lowered in comparison with the essential gradation luminance. Therefore, the video signals are converted so as to achieve a higher gradation than the essential gradation. This conversion converts the gamma to be closer to an ideal gamma curve, for example, rises to the 2.2^{th} power gamma curve.

The RGB independent gamma unit 42 corrects the gamma values of the video signals independently of RGB on the basis of the changed gamma. This correction is applied effectively when it is preferable to set the gamma independently of R, G and B as in the case of the liquid crystal of the OCB-mode, for example.

The FRC processor 44 carries out a FRC (Frame Rate Control) processing for the video signals of R, G and B, respectively. The FRC processor 44 is used when carrying out the gradation display corresponding to 10-bit using the 8-bit source driver, for example in 10-bit input video signals.

The source driver output converter 46 outputs the RGB video signals having subjected to the FRC process to the source driver 12.

### (4) Flashingless Driving Method

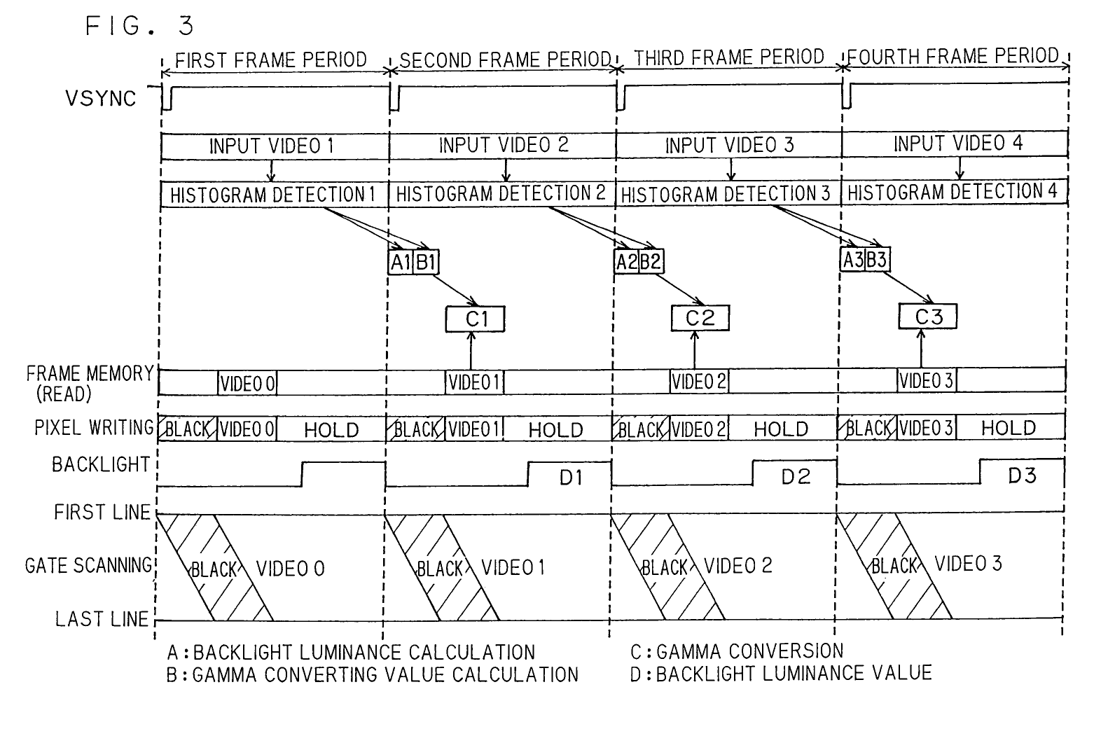

Referring now to a timing chart shown in FIG. 3, a flashingless driving method according to the liquid crystal display apparatus 10 in the first embodiment will be described.

The flashingless driving method includes a black writing period in which black video signals as the non-video signals are written during, for example, a first ¼ frame period, a video writing period in which the video signals are written during the subsequent ¼ frame period, and a video holding period in which the written video signals are held for 2/4 frame period in this order in the one frame period. Then, the backlight 11 is lit in the video holding period to display the video.

With this flashingless drive method, a black video is written at the beginning of the one frame period, so that the reverse transfer from the bent alignment to a spray alignment is prevented and a brilliant image is obtained. Since the backlight 11 is lit during the video holding period, flicker or the like does not occur in the video.

It is also possible to use the non-video signals having a higher voltage value than the black video signals instead of the black video signals. In this case, the display is gray, but almost no bad influence is exerted to the contrast by keeping the backlight 11 turned off, and the reverse transition may be effectively prevented. For example, the ratio of insertion of the non-video signals may further be shortened by using the non-video signals corresponding to the higher voltage value than the black video signals. Accordingly, a high display luminance may be obtained also under a high temperature environment which accelerates the probability of occurrence of the reverse transition. The ratio of insertion of the non-video signals may be adapted to be changed as needed on the basis of the environmental temperature.

### (5) Control State of Controller 14

Referring now to a timing chart in FIG. 3, the state of control of the video signals in the respective frame periods on the basis of the flashingless driving method described above will be described.

In FIG. 3, the first frame period to the fourth frame period are shown. In the periods from a first frame period to the fourth frame period, signals from the video signal 1 to a video signal 4 are entered respectively in this order. Here, the video signal 1 will be specifically described below.

### (5-1) First Frame Period

Firstly, in the entire first frame period, the video signal 1 is entered and stored in the frame memory 15. The histogram detector 30 detects the histogram of the video signal 1.

### (5-2) Black Writing Period in Second Frame Period

Subsequently, the backlight luminance calculator 34 calculates the backlight luminance value during a black writing period A1 in the second frame period.

Then, in a black writing period B1 in the second frame period, the gamma converting value calculator 38 calculates a gamma converting value of the video signal 1 using the video signal 1 and the calculated backlight illumination value.

### (5-3) Video Writing Period in Second Frame Period

Subsequently, in a video writing period C1 in the second frame period, the gamma converter 40 carries out the gamma conversion on the video signal 1 stored in the frame memory 15 using the calculated gamma converting value, and the RGB independent gamma unit 42, the FRC processor 44 and the source driver output converter 46 carry out the respective processes to write the video signal 1 in the respective pixels.

### (5-4) Video Holding Period in Second Frame Period

Subsequently, in the video holding period Dl in the second frame period, more specifically, in the video holding period after having completed the video writing, the backlight 11 is illuminated on the basis of the backlight luminance value calculated in the backlight luminance calculator 34.

Accordingly, the video signal 1 is displayed.

### (5-5) Video Signals 2 to 4

The video signals 2 to 4 are also subjected to the same processes as those shown above and are displayed at the same timing as the video.

### (6) Advantageous Effects

According to the first embodiment, when the video signal 1 after having converted the gamma on the basis of the video signal 1 is displayed by the above-described flashingless driving method, the backlight 11 is lit with the backlight luminance value calculated on the basis of the video signal 1 after having terminated the video display on the basis of the video signal 1. Therefore, the flashing phenomenon as in the related art does not occur. In other words, since the video display and the backlight luminance control occur at the same timing, occurrence of the flashing phenomenon when the image is switched from the dark image to the blight image, or deterioration of response in terms of visibility may be avoided.

### Second Embodiment

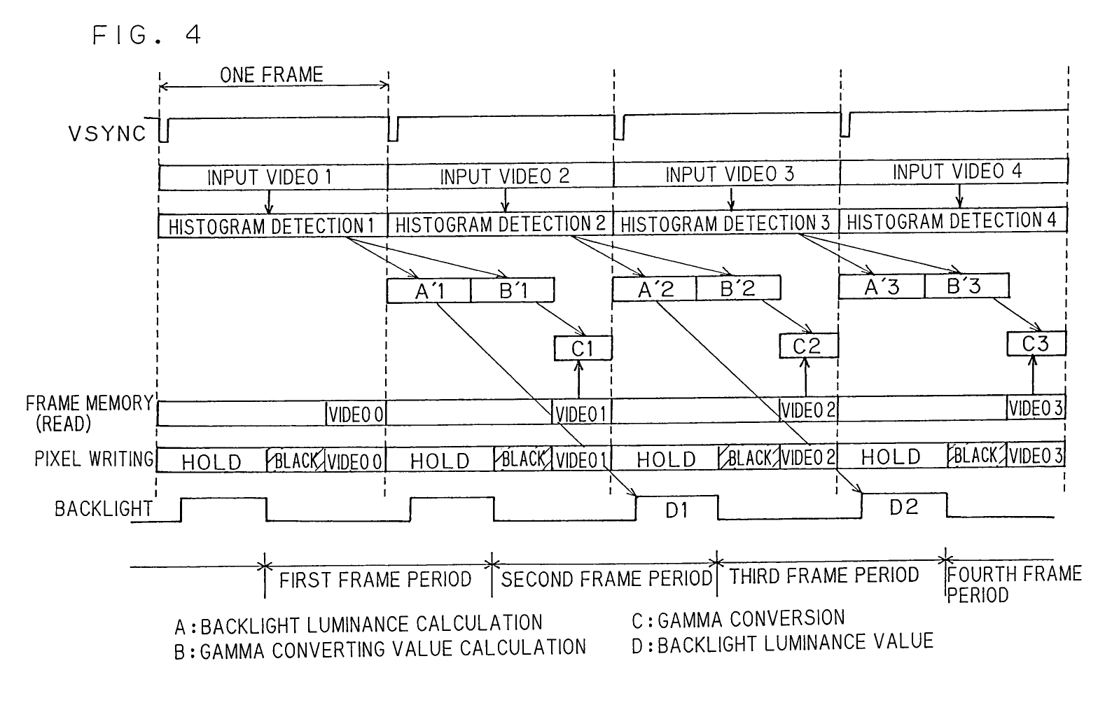

Referring now to FIG. 4, the state of control of the liquid crystal display apparatus of the OCB-mode according to a second embodiment will be described.

The different point of the second embodiment from the first embodiment is in the timing to calculate the backlight luminance value and the gamma converting value. In order to simplify the description, in the timing chart in FIG. 4, it is assumed that the one frame period in which the video signals for one frame are entered and the frame period in which the video is displayed are shifted by a time corresponding to the video holding period.

In the first embodiment, the backlight luminance value is calculated in the black writing period A1 in the second frame period and the gamma converting value is calculated in the period B. However, in the second embodiment, the backlight luminance value is calculated in a video holding period A′1 in the first frame period, which is one frame period before, and the gamma value is calculated in a black writing period B′1 in the second frame period.

Accordingly, even though the black writing period is shortened by the temperature, the calculating time is obtained in the video holding period in the first frame period, which is one frame period before, so that the video display and the gamma control are carried out at the same timing.

### Third Embodiment

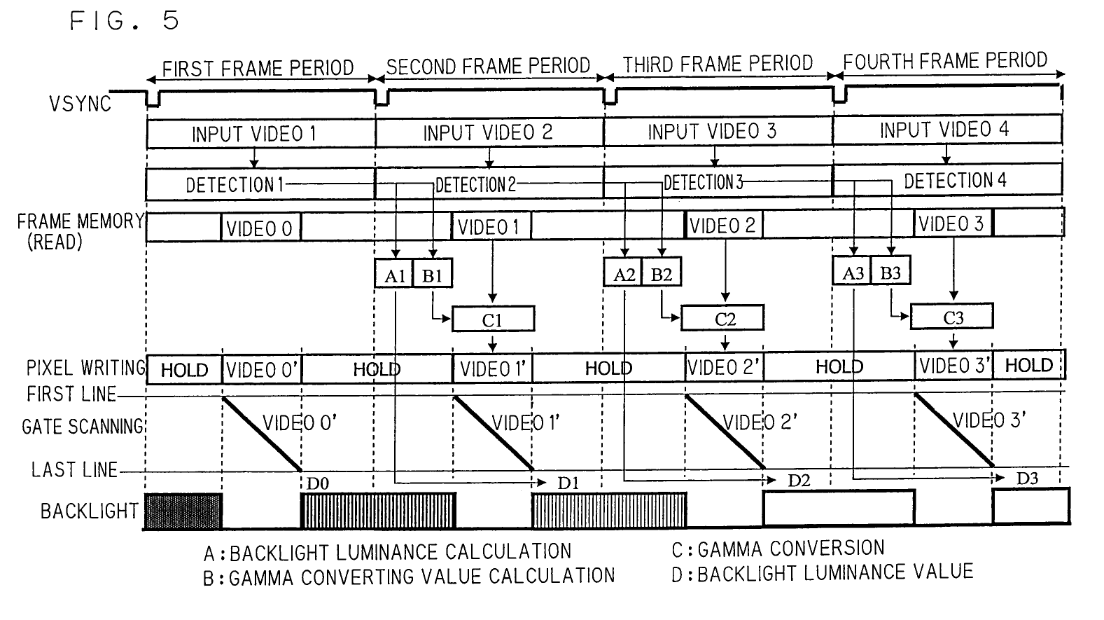

Referring now to FIG. 5, the state of control of the liquid crystal display apparatus according to a third embodiment will be described.

In the third embodiment, a liquid crystal display apparatus of a TN type is used instead of the liquid crystal display apparatus of the OCB-mode. The different point of the third embodiment from the first embodiment is that there is no non-video signal writing period and the video holding period comes next to the video writing period, and then the video writing period of the next frame comes next.

Then, in the third embodiment, the timing to light up the backlight 11 is brought to the timing after having started the video holding period, that is, after having completed all the scanning in one frame and having displayed the video. The luminance of the backlight 11 employed is the value calculated by the backlight luminance calculator 34 as in the first embodiment. The video signals to be displayed simultaneously are subjected to the gamma conversion on the basis of the gamma values obtained by the gamma converter 40.

The backlight 11 is turned off when starting the video writing period after having ended the video holding period.

According to the third embodiment, the backlight 11 is lit in the video holding period after having ended the video writing period, and the luminance of the backlight 11 in this case is adjusted on the basis of the luminance obtained by the backlight luminance calculator 34. Therefore, the flashing phenomenon does not occur and, even though the luminance of the backlight 11 is changed, it cannot be recognized visually by human being, so that the image quality is also improved.

### Fourth Embodiment

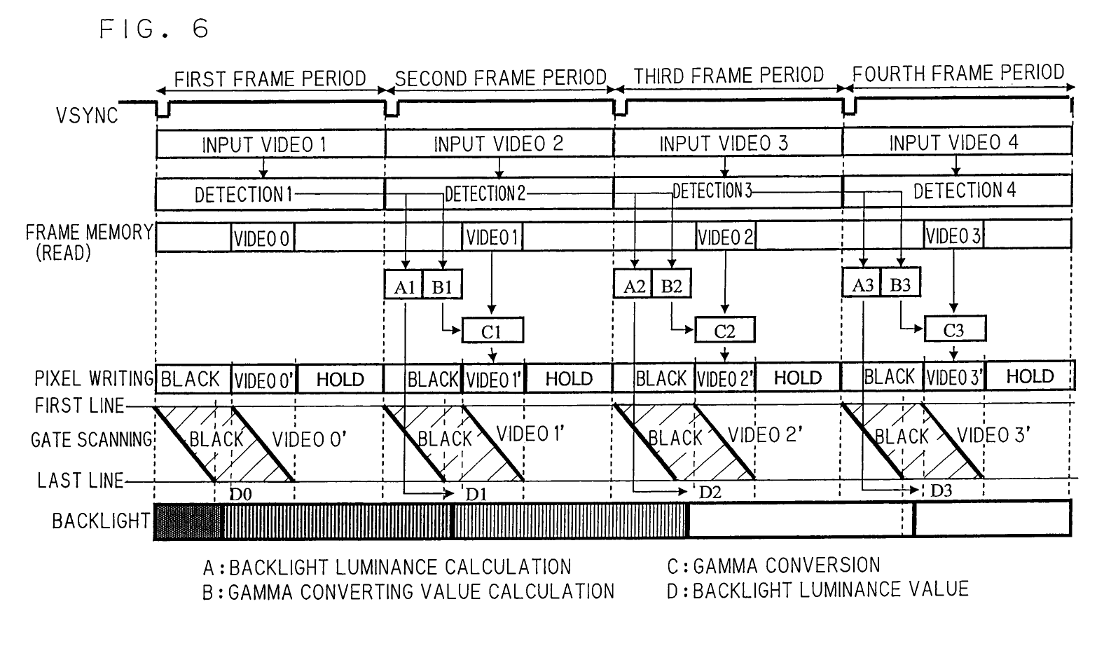

Referring now to FIG. 6, the state of control of the liquid crystal display apparatus of the OCB-mode in the fourth embodiment will be described.

The different point of the fourth embodiment from the first embodiment is that the backlight 11 is not turned on/off and is maintained in the illuminated state, and the luminance of the backlight 11 is adjusted in the non-video signal writing period.

In other words, when controlling the luminance of the backlight 11 on the basis of the luminance value calculated by the backlight luminance calculator 34, it is carried out in the non-video signal writing period or, more specifically, at the timing when the image display on the basis of the non-image signal is completed.

In the non-video signal writing period, even though the luminance of the backlight 11 is changed, it cannot be recognized easily by a user, and the flashing phenomenon does not occur. In particular, by using the black display signals as the non-video signals, the change in luminance of the backlight 11 is not recognized by the user.

### Fifth Embodiment

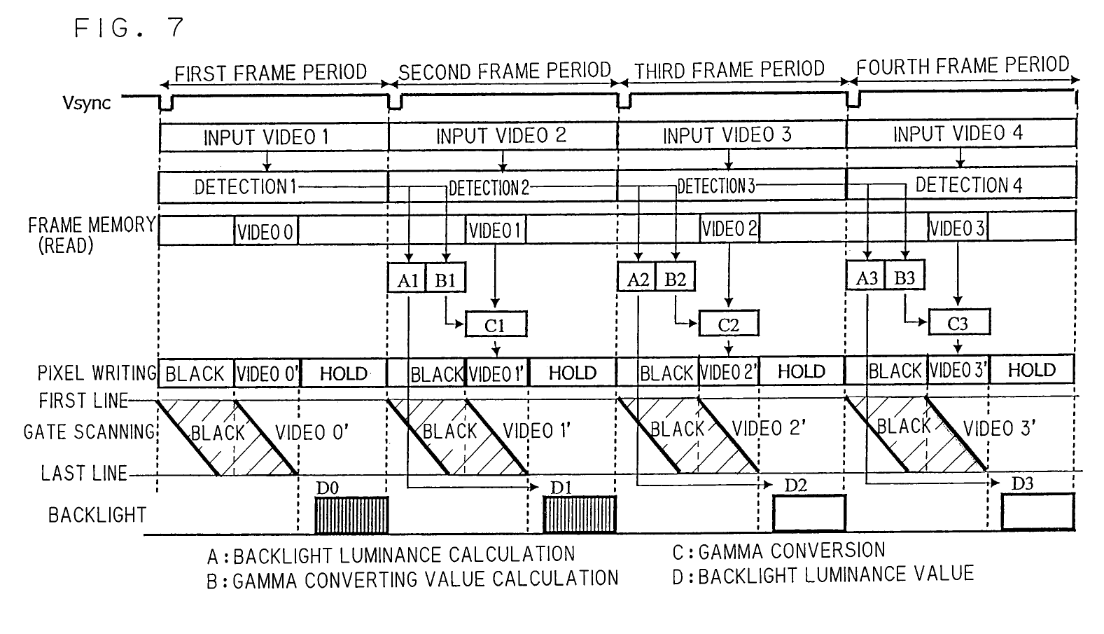

Referring now to FIG. 7, a state of controlling the liquid crystal display apparatus of the OCB-mode according to a fifth embodiment will be described.

The different point of the fifth embodiment from the first embodiment is the method of obtaining the gradation scale information as a reference for the backlight luminance calculator 34 and the gamma converting value calculator 38.

In other words, in the first embodiment, the gradation scale information in the video signals for one frame period is obtained by the histogram detector 30. However, in the fifth embodiment, the gradation distribution of the video signals in the one frame period is obtained, and the gradation value at a peak in this gradation distribution is outputted to the backlight luminance calculator 34 and the gamma converting value calculator 38 as the gradation scale information.

The backlight luminance calculator 34 calculates the backlight luminance on the basis of the gradation value at the peak, and the gamma converting value calculator 38 obtains the gamma converting value on the basis of the gradation value at the peak.

It is also possible to use a maximum gradation value in the one frame period, or an average gradation value instead of the gradation value at the peak. Then, the backlight 11 is lit after having started the video holding period using the luminance value of the backlight 11 calculated in this manner.

The timing of illumination of the backlight 11 is preferably not at the same time as the timing when the writing of the video for one frame is ended, but after having elapsed a predetermined time.

### Sixth Embodiment

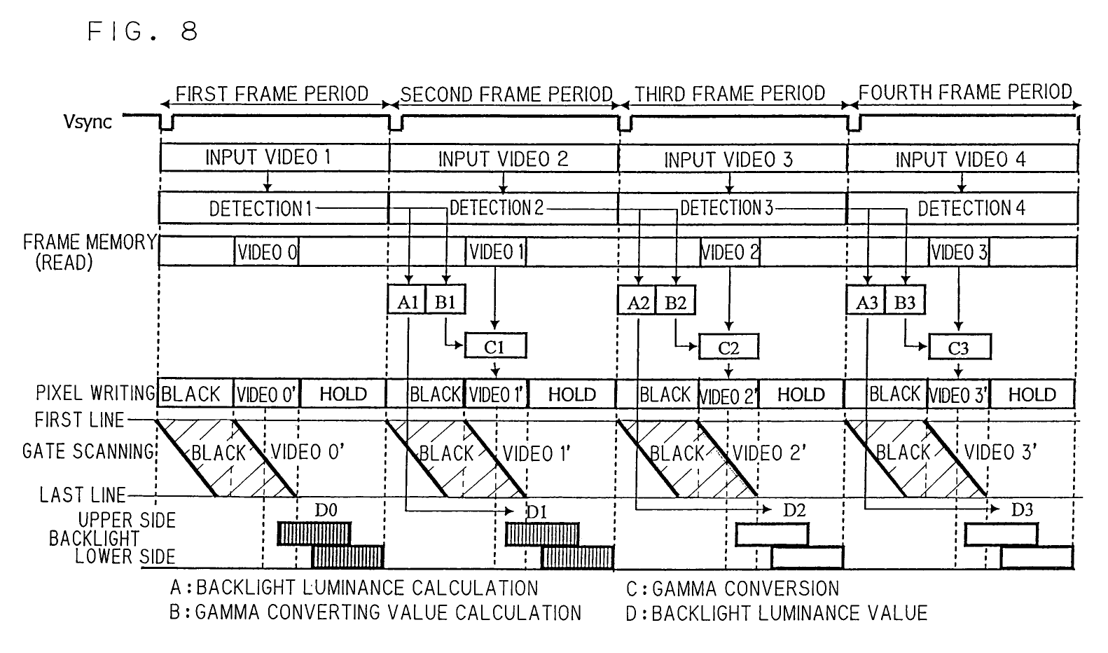

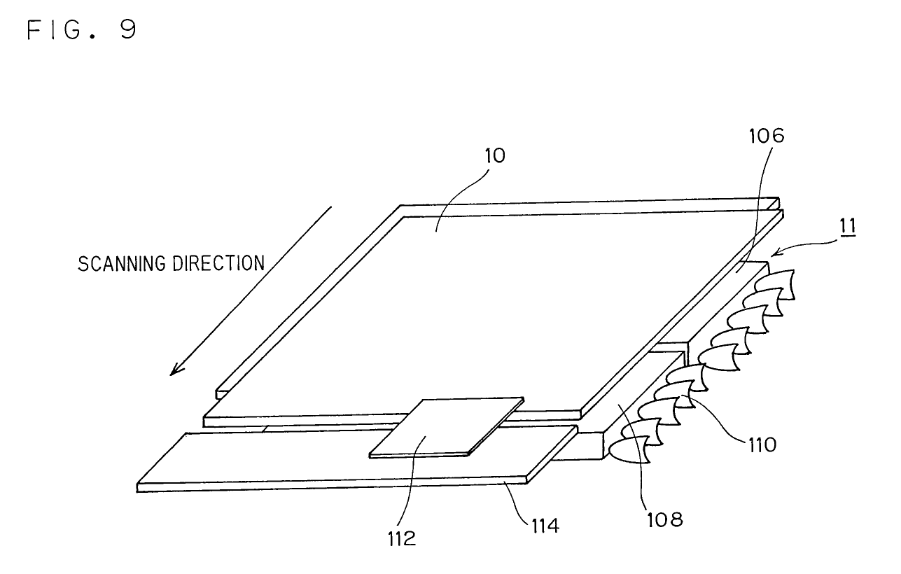

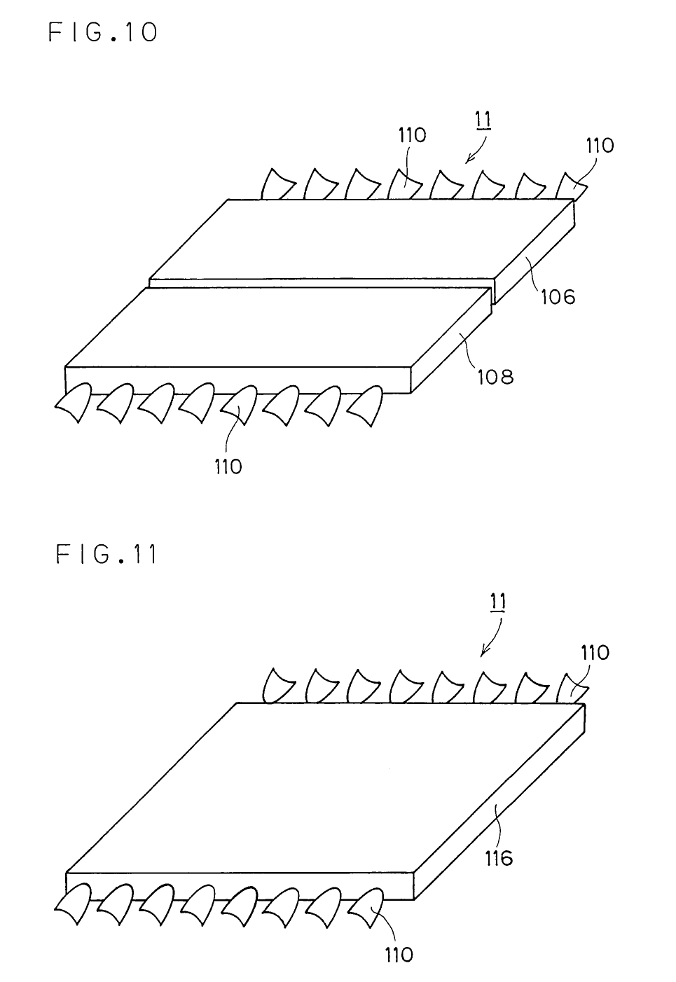

Referring now to FIG. 8 and FIG. 9, a state of control of the liquid crystal display apparatus of the OCB-mode according to a sixth embodiment will be described.

### (1) Configuration of Liquid Crystal Display Apparatus

Referring first to FIG. 9, the configuration of the liquid crystal display apparatus according to the sixth embodiment will be described.

The backlight 11 is arranged on the lower surface of the liquid crystal panel 10 of the liquid crystal display apparatus, the liquid crystal panel 10 includes an FPC 112 mounted thereto, and the FPC 112 includes a PCB 114 mounted thereto.

The backlight 11 includes an upper light guide plate 106 and a lower light guide plate 108, as divided into two parts arranged side-by-side in the direction orthogonal to the scanning lines (the scanning direction), and a plurality of LEDs 110 are mounted to short sides of the upper and lower light guide plates 106, 108 on one side respectively.

Accordingly, the backlight 11 is adapted to illuminate independently by the upper light guide plate 106 and the lower light guide plate 108.

(2) A method of Controlling Backlight 11

In the backlight 11 as described above, according to the sixth embodiment, the upper light guide plate 106 is lit at the timing when the video writing on an upper portion of the liquid crystal panel which corresponds to the upper light guide plate 106 is ended, and the lower light guide plate 108 is lit at the timing when the writing of the video to the lower portion of the liquid crystal panel which corresponds to the lower light guide plate 108 is ended as shown in FIG. 8.

Accordingly, by lighting up the upper half and the lower half of the backlight 11 independently after having ended the video writing respectively, the numerical aperture of time may be increased. As regards the turning off of the backlight 11 as well, the upper light guide plate 106 is turned off at the timing when the non-video writing of the upper portion of the liquid crystal panel which corresponds to the upper light guide plate 106 is started, and then the lower light guide plate 108 is turned off at the timing when the non-video wiring on the lower portion of the liquid crystal panel which corresponds to the lower light guide plate 108 is started, so that occurrence of luminance inclination in the screen is also prevented.

### (3) Modification 1

As Modification 1 of the backlight 11 in the embodiments of the invention, it is also effective to control the backlight by dividing the same into three or more parts or regions other than only two parts or regions, for a large screen. As regards the arrangement of the light sources, it is also applicable to arrange the plurality of LEDs 110 on the upper side of the upper light guide plate 106 and arrange the plurality of LEDs 110 on the lower side of the lower light guide plate 108, as shown in FIG. 11.

### (4) Modification 2

As Modification 2 of the backlight 11 in the embodiments of the invention, the plurality of LEDs 110 are arranged along the upper side of one light guide plate 116, and the plurality of LEDs 110 are arranged along the lower side thereof, as shown in FIG. 11.

When illuminating the upper portions of the light guide plate 116, only the LEDs 110 on the upper side are lit and when illuminating the lower portion of the light guide plate 116, only the LEDs 110 on the lower side are lit.

### Modifications

The invention is not limited to the embodiments shown above, and may be modified in various manners without departing the scope of the invention.

For example, in the embodiment shown above, the liquid crystal display apparatus of the OCB-mode has been described. However, the invention is also applicable to the liquid crystal display apparatuses of TN-type, VA-type, IPS-type, ferroelectric-type, or anti-ferroelectric-type.

The speed of response of these types of liquid crystal is preferably 5 m/sec at maximum, more specifically, when writing the non-video signals, the liquid crystal of the OCB-mode is preferable.

What is claimed is:

1. A liquid crystal display apparatus comprising:
a liquid crystal panel having a plurality of signal lines, a plurality of scanning lines and a plurality of pixels arranged in a matrix form;
a backlight that illuminates the liquid crystal panel;
a source driver that outputs video signals and non-video signals to the respective signal lines;
a gate driver that outputs gate signals to the respective scanning lines; and
a control unit that stores an input video signals and calculates distribution of gradation values of the input video signals, and that controls the backlight, the source driver, and the gate driver based on the input video signal and the distribution of gradation values during each frame period which is divided into a first period for writing the non-video signals to the respective pixels, a second period subsequent to the first period for writing the video signals to the respective pixels, and a third period subsequent to the second period for maintaining the video signals in the respective pixels,
wherein the control unit
(1) calculates a backlight luminance value and gamma conversion values based on the distribution of the gradation values prior to the second period,
(2) gamma-converts the input video signals based on the gamma conversion values and writes gamma-converted video signals into the respective pixels during the second period, and
(3) causes the backlight to emit light based on the backlight luminance value during the third period.

2. A liquid crystal display apparatus comprising:
a liquid crystal panel having a plurality of signal lines, a plurality of scanning lines and a plurality of pixels arranged in a matrix form;
a backlight that illuminates the liquid crystal panel;
a source driver that outputs video signals and non-video signals to the respective signal lines;
a gate driver that outputs gate signals to the respective scanning lines; and
a control unit that stores an input video signals and calculates distribution of gradation values of the input video signals, and that controls the backlight, the source driver, and the gate driver based on the input video signal and the distribution of gradation values during each frame period which is divided into a first period for writing the non-video signals to the respective pixels, a second period subsequent to the first period for writing the video signals to the respective pixels, and a third period subsequent to the second period for maintaining the video signals in the respective pixels,
wherein the control unit
(1) calculates a backlight luminance value and gamma conversion values based on the distribution of the gradation values during the first period,
(2) gamma-converts the input video signals based on the gamma conversion values and writes gamma-converted video signals into the respective pixels during the second period, and
(3) causes the backlight to emit light based on the backlight luminance value during the third period.

3. A liquid crystal display apparatus comprising:
a liquid crystal panel having a plurality of signal lines, a plurality of scanning lines and a plurality of pixels arranged in a matrix form;
a backlight that illuminates the liquid crystal panel;
a source driver that outputs video signals to the respective signal lines;
a gate driver that outputs gate signals to the respective scanning lines; and
a control unit that stores an input video signals and generates gradation scale information of the input video signals, and that controls the backlight, the source driver, and the gate driver based on the input video signal and the gradation scale information during each frame period which is divided into a first period for writing the video signals to the respective pixels, and a second period subsequent to the first period for maintaining the video signals in the respective pixels,
wherein the control unit
(1) calculates a backlight luminance value and gamma conversion values based on the gradation scale information prior to the first period,
(2) gamma-converts the input video signals based on the gamma conversion values, writes gamma-converted video signals into the respective pixels, and puts the backlight into off-state during the second period, and
(3) puts the backlight into on-state based on the backlight luminance value during the second period.

4. A liquid crystal display apparatus comprising:
a liquid crystal panel having a plurality of signal lines, a plurality of scanning lines and a plurality of pixels arranged in a matrix form;
a backlight that illuminates the liquid crystal panel;
a source driver that outputs video signals and non-video signals to the respective signal lines;
a gate driver that outputs gate signals to the respective scanning lines; and
a control unit that stores an input video signals and calculates gradation scale information of the input video signals, and that controls the backlight, the source driver, and the gate driver based on the input video signal and the gradation scale information during each frame period which is divided into a first period for writing the non-video signals to the respective pixels, a second period subsequent to the first period for writing the video signals to the respective pixels, and a third period subsequent to the second period for maintaining the video signals in the respective pixels,
wherein the control unit
(1) calculates a backlight luminance value and gamma conversion values based on the gradation scale information prior to the second period,
(2) gamma-converts the input video signals based on the gamma conversion values and writes gamma-converted video signals into the respective pixels during the second period, and
(3) causes the backlight to emit light based on the backlight luminance value during the third period.

5. A liquid crystal display apparatus comprising:
a liquid crystal panel having a plurality of signal lines, a plurality of scanning lines and a plurality of pixels arranged in a matrix form;
a backlight that illuminates the liquid crystal panel;
a source driver that outputs video signals and non-video signals to the respective signal lines;
a gate driver that outputs gate signals to the respective scanning lines; and
a control unit that stores an input video signals and calculates gradation scale information of the input video signals, and that controls the backlight, the source driver, and the gate driver based on the input video signal and the gradation scale information during each frame period which is divided into a first period for writing the non-video signals to the respective pixels, a second period subsequent to the first period for writing the video signals to the respective pixels, and a third period subsequent to the second period for maintaining the video signals in the respective pixels,
wherein the control unit
(1) calculates a backlight luminance value and gamma conversion values based on the gradation scale information during the first period,
(2) gamma-converts the input video signals based on the gamma conversion values and writes gamma-converted video signals into the respective pixels during the second period, and
(3) causes the backlight to emit light based on the backlight luminance value during the third period.

6. The liquid crystal display apparatus according to one of claims 1 to 5, wherein the backlight is divided into a plurality of separate parts or regions, which are arranged side-by-side in a direction orthogonal to the scanning lines and each of which emits light independently with each other part or region; and
each of the separate parts or regions of the back light emits light based on the backlight luminance value.

7. The liquid crystal display apparatus according to one of claims 1 to 5, wherein the liquid crystal panel is of OCB-mode.

8. The liquid crystal display apparatus according to one of claims 1, 2, 4 and 5, wherein the non-video signals correspond to black display.
